(19) United States
(12) Patent Application Publication
(10) Pub. No.: US 2021/0127600 A1
(43) Pub. Date: May 6, 2021

(54) CLIP, AND CLIP AND CORD SYSTEM AND METHOD

(71) Applicant: NINE IP LIMITED, Auckland (NZ)

(72) Inventor: Jonathan Dallas TOYE, Auckland (NZ)

(73) Assignee: Nine IP Limited, Auckland (NZ)

(21) Appl. No.: 17/041,894

(22) PCT Filed: Mar. 29, 2019
(86) PCT No.: PCT/IB2019/052580

§ 371 Date: Sep. 25, 2020

(30) Foreign Application Priority Data
Apr. 3, 2018 (NZ) 741278
Apr. 5, 2018 (NZ) 741351

(51) Int. Cl. A01G 13/02; F16B 45/04

(52) U.S. Cl. CPC A01G 13/0268; F16B 2/12; F16B 45/04

(57) ABSTRACT

A clip for fixing an agricultural ground sheet cover material, or a netting, in place comprises two inter-engageable parts, each part having a jaw at one end for gripping sheet material or netting between the jaws when the two inter-engageable parts are closed together, a locking tab on one of the inter-engageable parts, a locking bar on the other of the inter-engageable parts, and and cord engaging formations at an opposite end of at least one of the inter-engageable clip parts, adapted to grip a cord between the cord engaging formations to lock the cord to the clip.

### FIELD OF THE INVENTION

This invention relates to a clip, a clip and cord system, and method for fixing a sheet material particularly but not exclusively a ground cover material, or a netting in place.

### BACKGROUND

Ground cover materials are used in agriculture for a number of purposes, such as moisture retention, water conservation, weed or sward suppression, soil warmth retention, and light reflecting.

Typically where the material is used primarily as a light reflective ground cover, the material is rolled out in lengths onto the ground between rows of trees in an orchard, rows of vines in a vineyard, or rows of berry fruit plants for example, to increase the amount of light to which the plants and in particular fruit are exposed, by reflection of light from the material towards the fruit above. Each length of the sheet material needs to be suitably secured in place against movement due to wind, which may apply substantial loading, or traffic over the material.

The sheet material will typically remain in place for some months, before being removed and reused in a subsequent growing season or on another crop in the same growing season.

U.S. Pat. No. 6,823,565 discloses a fastening system for anchoring agricultural sheet material by fastening claws including prongs to pierce the material, and elastic cords.

Nettings are used in agriculture over or adjacent plants to protect the plants from birds, insects, excessive sun, wind or hail.

### SUMMARY OF THE INVENTION

In broad terms in a first aspect the invention comprises a clip comprising:
two inter-engageable parts, each part having a jaw at one end for gripping sheet material or netting between the jaws when the two inter-engageable parts are closed together,
a locking tab on one of the inter-engageable parts,
a locking bar on the other of the inter-engageable parts, the locking bar engageable by the locking tab when the parts are inter-engaged, to lock the two clip parts closed together, and
cord engaging formations at an opposite end of at least one of the inter-engageable clip parts, adapted to grip a cord between the cord engaging formations to lock the cord to the clip.

In broad terms in a second aspect the invention comprises a clip and cord system comprising:
a cord,
a clip attached to a first end of the cord, and
a hook engagable with the cord attached to a second end of the cord.

In broad terms in a third aspect the invention comprises a clip engagable on an edge of a sheet material or netting to grip the sheet material or netting edge and comprising cord engaging formations on either side of a lengthwise cord channel from opposite sides of the cord channel and adapted to grip a cord to lock the cord to the clip

In broad terms in a fourth aspect the invention comprises a method for fixing a sheet material or netting, the method comprising:
providing cord(s) comprising first and second ends, and clips(s) and hook(s) engageable with the cord(s), each clip comprising two inter-engageable parts, each part having a jaw at one end for gripping sheet material or netting between the clip jaws when the clip is closed, and cord engaging formations at an opposite end of at least one of the clip parts, adapted to grip a cord between the cord engaging formations to lock the cord to the clip,
engaging clip(s) at spaced locations along a material or netting edge, closing the clip(s) by sliding the first inter-engageable clip part into the second inter-engageable part until the clip jaws are fully closed onto the material or netting edge, and locking the clip parts together to fix the clip on the material or netting edge,
attaching the first end of the cord(s) to the cord engaging formation of the clip(s),
attaching the second end of the cord(s) to the hook(s), and looping each cord around or otherwise attaching the cord to an object and then hooking back onto itself.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

### BRIEF DESCRIPTION OF THE DRAWINGS

The invention is further described with reference to the accompanying drawings, which show one or more embodiments by way of example only, in which:

FIG. 1 shows use of a ground cover material and fixing of the ground cover material in place by the use of a clip and cord system of the invention,

FIG. 2 is a closer view of a first embodiment of a clip attached to a sheet of the ground cover material,

FIG. 3 is a view of the clip approaching an edge of the sheet of ground cover material,

FIG. 4 is a view of the clip of FIG. 3 closed on and attached to an edge of the sheet of ground cover material,

FIG. 5 is a cross-section view along line A-A of FIG. 4,

FIG. 6 is a perspective view of the clip, with the two parts of the clip assembled together,

FIG. 6a is a perspective view of a second embodiment of the invention clip,

FIG. 7 is a perspective view of one part of the first embodiment clip, dis-assembled from the other part,

FIG. 7a is a perspective view similar to FIG. 7 but of one part of the second embodiment clip dis-assembled from the other part,

FIG. 8 is a perspective view of the other part of the first embodiment clip,

FIG. 8a is a perspective view similar to FIG. 8 but of the other part of the second embodiment clip,

FIG. 9 is a view of one end of one part of the clip without a cord attached,

FIG. 10 is a view of one end of one part of the clip with a cord attached,

FIG. 11 is a view of the hook on the other end of the cord approaching an intermediate part of the cord to attach to it,

FIG. 12 is a view similar to that of FIG. 11 but now with the hook attached to the intermediate part of the cord,

FIG. 13 is a side view of the hook with the cord locked between a longitudinal cut-out of the hook,

FIG. 14 is a view similar to that of FIG. 13 but now with the cord unlocked from the longitudinal cut-out of the hook,

FIG. 15 is a view similar to that of FIG. 13 but now with one end of the cord knotted and locked between the longitudinal cut-out of the hook,

FIG. 16 is a view similar to that of FIG. 15 but now with a knotted end of the cord retained in a cord retaining clip and the intermediate part of the cord locked between the longitudinal cut-out of the hook, and

FIG. 17 is a view similar to that of FIG. 12 but now with the hook mounted onto the cord in reverse and with the hook attached to the intermediate part of the cord.

### DETAILED DESCRIPTION OF EMBODIMENTS

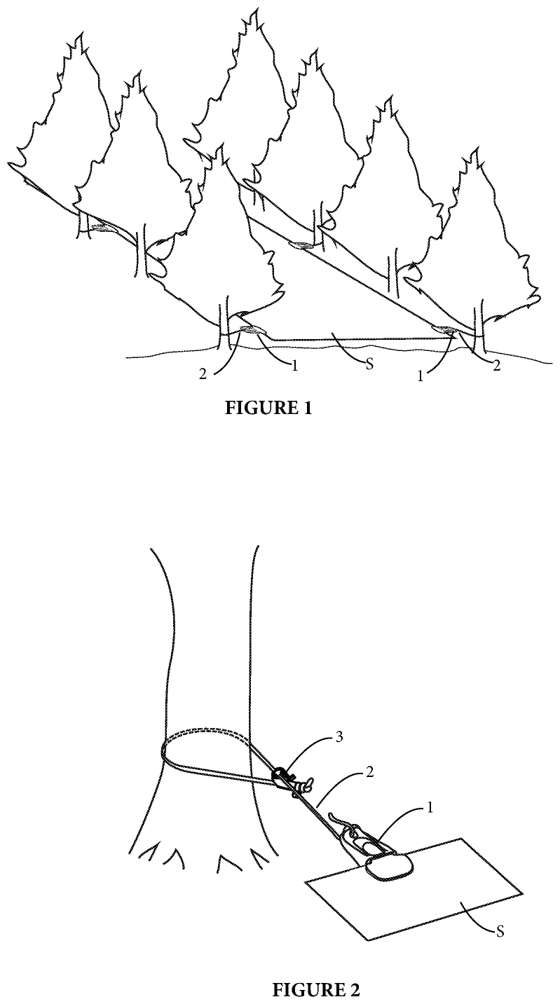

Referring to FIG. 1, agricultural sheet material S, which may for example have reflective properties to reflect solar radiation onto the fruit trees and fruit from below, is anchored underneath agricultural crops such as rows of orchard trees as a ground cover. In FIG. 1 only part of the sheeting is shown. Typically long sections of the sheet material are anchored along both edges between rows of orchard trees or vines. The material may be for example woven from flat warp and weft tapes of a plastics material. Fastening clips 1 connect to the sheet material S along its edges, and in turn each clip 1 connects to an elastic or extensible cord 2. Each cord 2 at its other end may loop around the trunk of one of spaced trees as shown and be hooked back on itself as shown in FIG. 2 by hook 3 carried on an opposite end of cord 2 to clip 1, or may be attached to a staple hammered into the trunk, or alternatively to stakes or pegs hammered into the ground, or to a wire extending along the row of the trees or vines, for example.

FIG. 2 is a closer view of a clip 1 attached to the sheet of the ground cover material S (shown only in part).

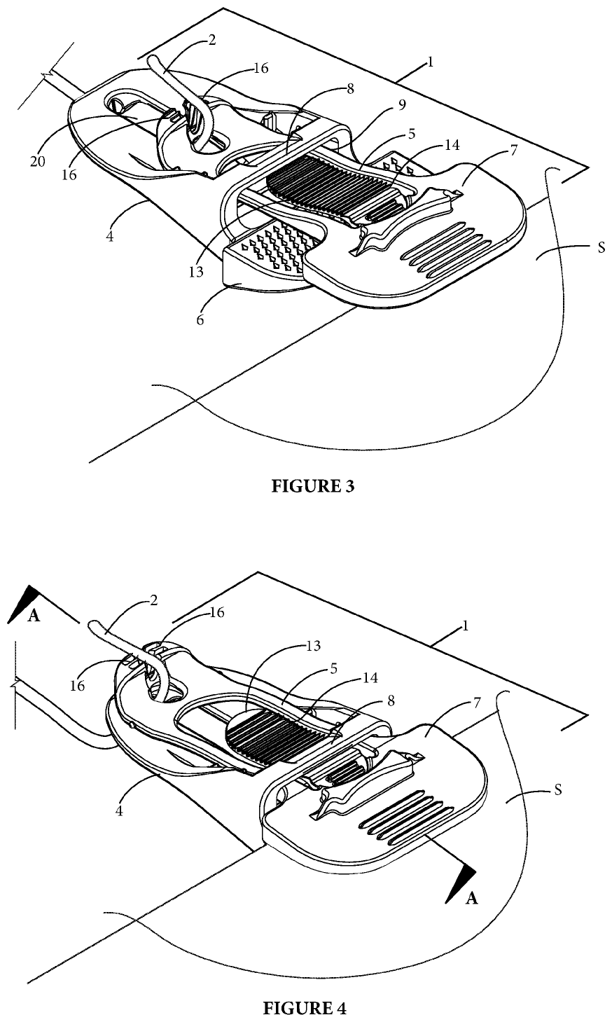

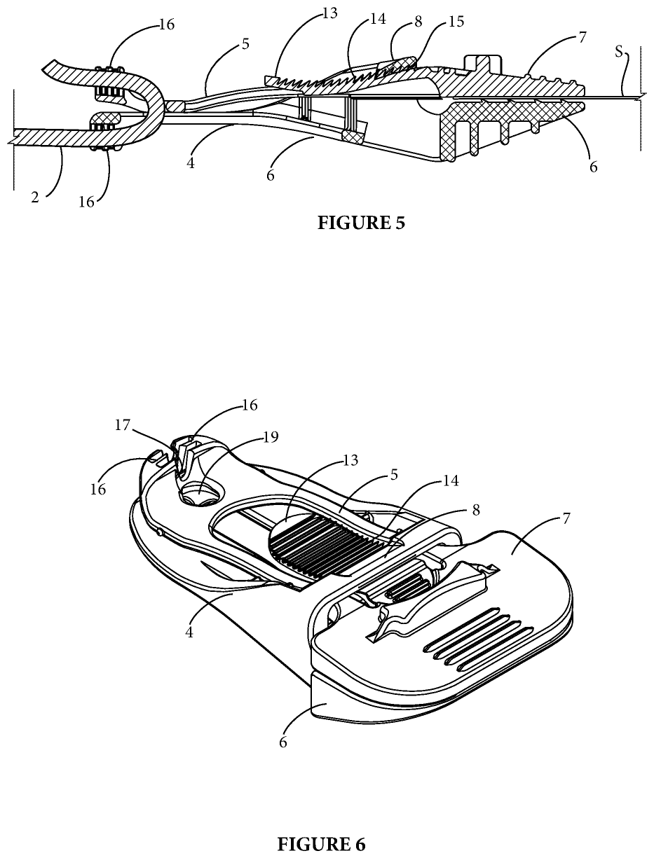

FIG. 3 is a view of an open clip 1 approaching an edge of sheet material S and FIGS. 4 and 5 show the clip closed on and attached to the material edge.

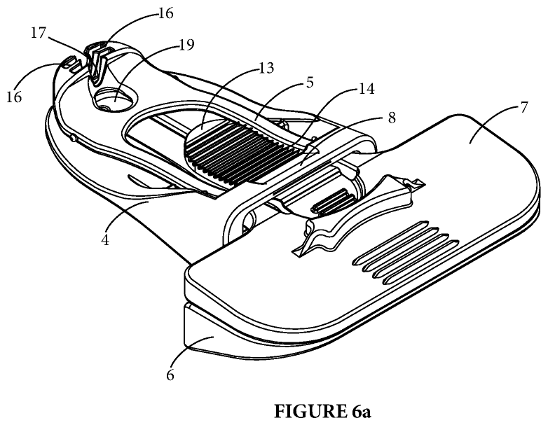

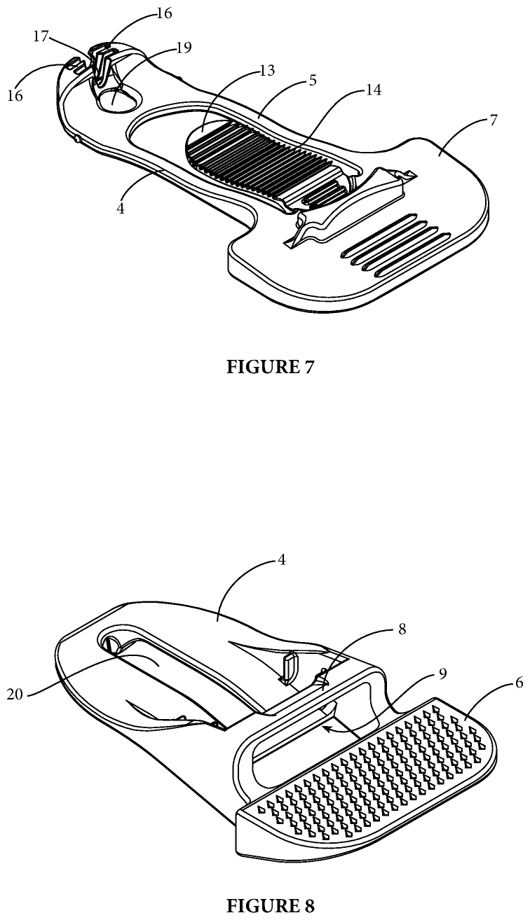

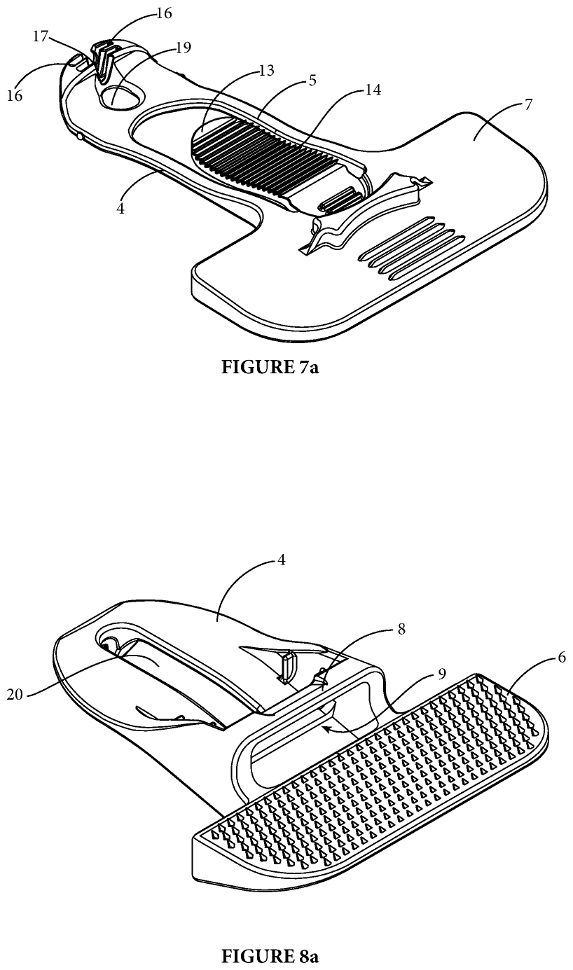

FIG. 6 shows clip 1 with the two parts of the clip assembled together, and FIGS. 7 and 8 show the two dis-assembled clip parts. Referring in particular to FIGS. 6 to 8, the clip comprises parts 4 and 5 which inter-engage together. The clip parts 4 and 5 have jaws 6 and 7 at one end for gripping sheet material between the clip jaws when the clip is closed see FIG. 5. FIG. 6a shows a second embodiment of clip 1 having wider jaws 6 and 7. FIGS. 7a and 8a show the two dis-assembled clip parts, each having wider jaws 6 and 7. One of the clip parts 4 comprises a transverse locking bar 8 which defines beneath it transverse aperture 9, into which the other clip part 5 is inserted when the two parts of the clip are assembled together. When the two parts of the clip are assembled together but the clip is open, as shown in FIG. 3, the jaws 6 and 7 are spaced from each other, and the clip can be engaged onto a material edge, so that the material edge is fully home between the clip jaws. Then in use to close the clip, the clip part 5 is pushed further home through the aperture 9 beneath locking bar 8 on clip part 4 to close the clip, until the clip jaws are fully closed onto the material edge, as shown in FIGS. 4 and 5.

Clip part 5 comprises a longitudinally extending detent 13 adapted to engage the locking bar 8 to lock the clip parts together when the clip is closed, and in particular in the embodiment shown, on the underside of locking bar 8. The detent 13 comprises one or more teeth 14 which ratchet engage the locking bar 8. Also in the embodiment shown, complementary ratchet teeth 15 are provided on the underside of the locking bar 8 see FIG. 5, which engage the teeth 14 on detent 13. The multiple ratchet teeth 14 on detent 13 provide a number of discrete positions in which the clip part 5 can be locked with the clip part 4. However in other embodiments the two clip parts may comprise only a single lock or snap fit together position.

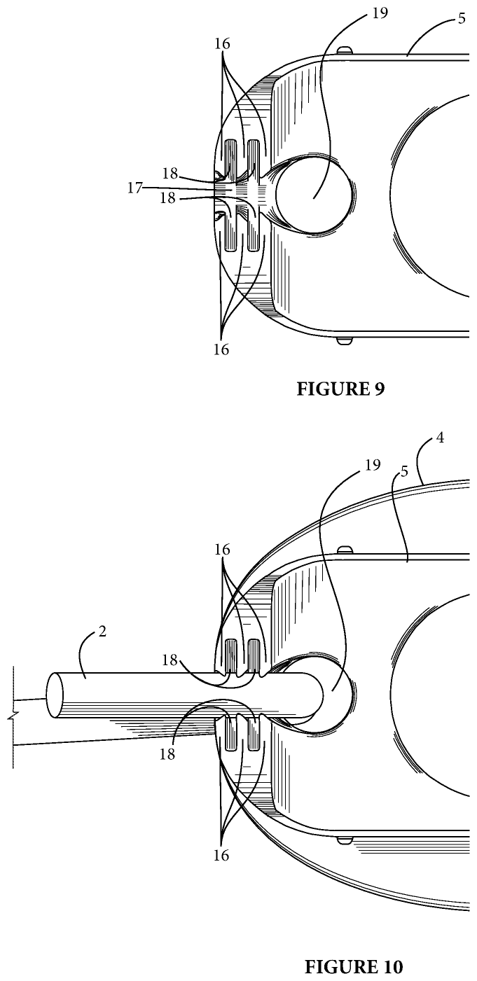

Cord engaging formations 16 are provided at an opposite end of at least one of the clip parts, and in the embodiment shown at the end of both clip parts 4 and 5, adapted to grip cord 2 between the formations to lock the cord to the clip. FIG. 9 is a view of the end of clip part 5 without a cord attached, and FIG. 10 is a view of the same clip part with cord 2 attached. In the embodiment shown, the cord engaging formations 16 are on either side of a lengthwise cord channel 17 for the cord in the end of the clip part. In the embodiment shown the formations 16 comprise three projections from either side towards the cord channel as shown, each with a tooth edge to bite into the cord, but in alternative embodiments there may be more, or less such as a pair of adjacent projections from each side of the cord channel. In the embodiment shown the three cord engaging formations or projections 16 on each side of the cord channel define two slots 17 between them.

In the embodiment shown the formations 16 are transverse to a longitudinal axis of the clip part, and in use to engage the cord 2 with the clip part the cord is pushed down into the cord channel between the clip parts, but in other embodiments the formations 16 may be angled relative to the longitudinal axis of the clip part and in use the cord is pushed down and also pulled rearwardly to lock the cord to the clip part. In the embodiment shown, the first pair of formations 16 is angled away from the jaw end of the clip and the second and third pairs of formations are angled towards the jaw end of the clip to prevent movement of cord 2 in both directions. In an alternative embodiment however the cord engaging formations may be similarly angled relative to the longitudinal axis of the clip, such as all angled towards the jaw end of the clip. One or both (as in the embodiment shown) of the clip parts 4 and 5 may comprise the cord engaging formations 16 at the end opposite the jaws of the clip parts.

In the embodiment shown where both of the clip parts 4 and 5 are provided with the cord engaging formations 16, cord apertures 19 and 20 are provided through each of the clip parts, near the cord engaging formations 16. The aperture 20 through one of the clip parts is an elongate slot aperture. The cord engaging formations 16 are provided on the respective sides of the clip parts 4 and 5 such that when the clip parts are assembled together, the cord 2 may be ‘jammed’ into the cord engaging formation on one clip part, pass through cord apertures 19 and 20, and be also jammed into the cord engaging formation on one clip part—see FIGS. 4 and 5.

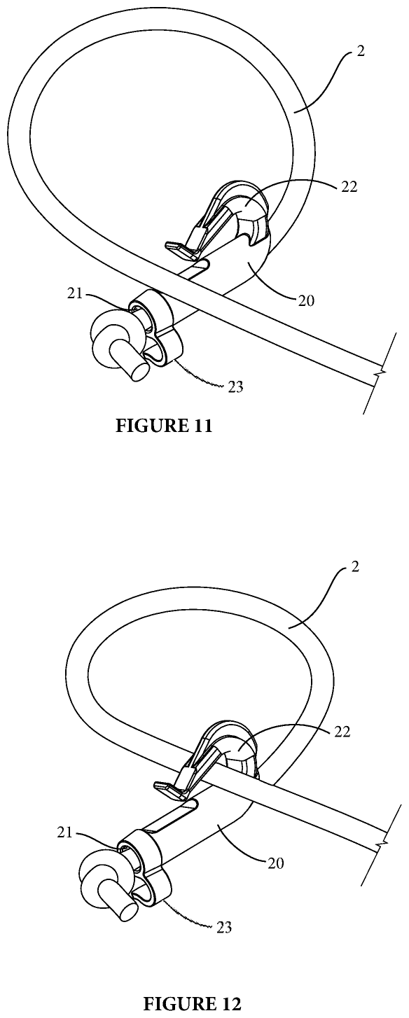

As stated an attachment system according to the invention comprises a clip 1 as described, a cord 2, and may also comprise a hook 3 engagable with the cord. FIG. 11 is a view of a hook 3 on the other end of the cord approaching an intermediate part of the cord to attach to it, and FIG. 12 is a view similar to that of FIG. 11 but now with the hook attached to the intermediate part of the cord. FIG. 17 is a view of hook 3 mounted onto cord 2 in reverse when compared to the arrangement in FIGS. 11 and 12. The clip 1 is attached to one end of the cord 2 and the hook 3 is attached to the other end. In the embodiment shown the hook comprises an elongate body 20 having an aperture 21 through which the cord passes so that the hook is slidably mounted on the cord 2, and a curved hook section 22. In use, usually after the clip has been attached to the sheet material or netting edge, or multiple clips spaced along the sheet material or netting opposite edges, then each cord is looped around a tree or trees or stakes etc or otherwise attached to an object, and then hooked back onto itself. The position of the cord in the cord engaging formations 16 on the clip is then adjusted so that the cord is tight, for each clip.

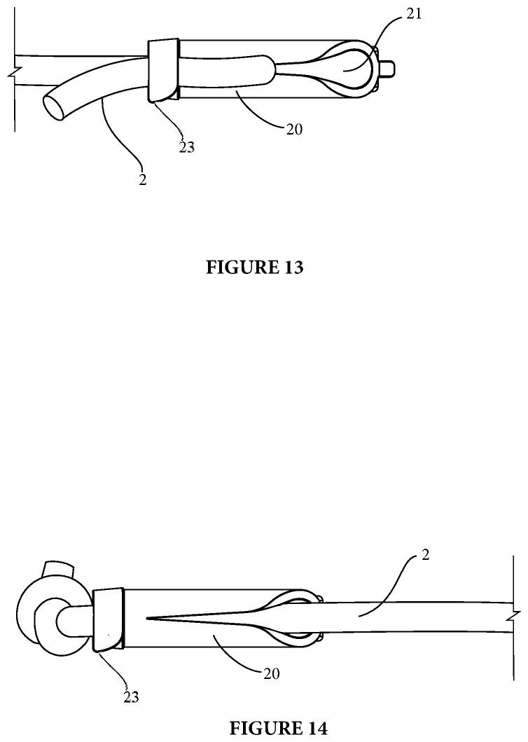

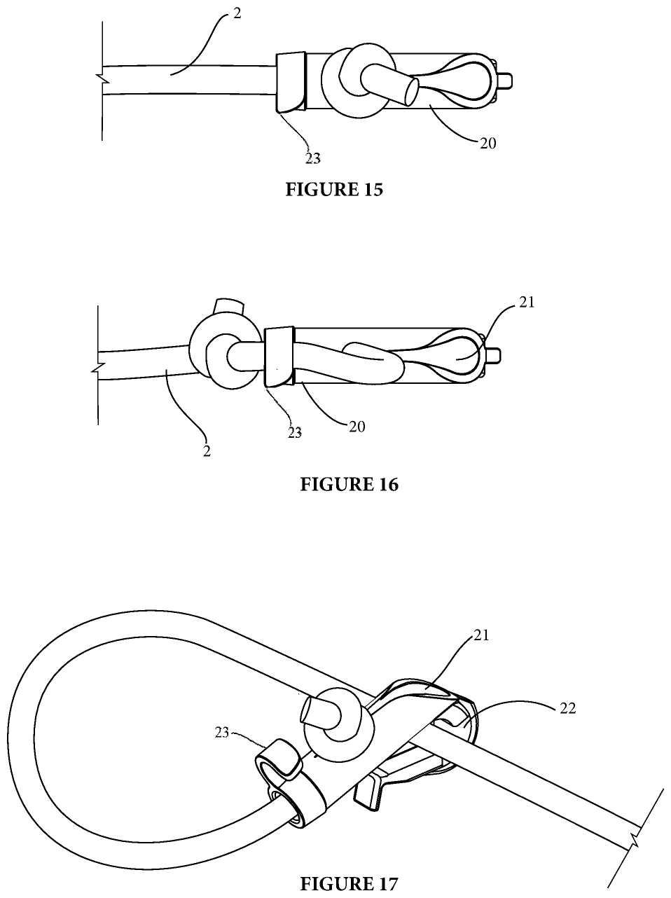

FIG. 14 is a view of the elongate body 20 of hook 3 slidably mounted onto cord 2. The body 20 comprises a longitudinal cut-out at the at the curved hook section end. In the embodiment shown, the elongate body 20 comprises a cord retaining clip 23 at the end opposite the curved hook section adapted to hold a cord. FIG. 15 shows one end of the cord 2 knotted and locked between the longitudinal cut-out of the hook, FIG. 16 shows a knotted end of the cord 2 retained in a cord retaining clip 23 integrally formed as part of the hook 3, and the intermediate part of the cord locked between the longitudinal cut-out of the hook. When in use, hook 3 is slidably mounted onto cord 2, the cord 2 may be ‘jammed’ into the longitudinal cut-out to prevent movement of hook 3 relative to cord 2 see FIGS. 13 and 15.

The invention is described above in relation to fixing a sheet material over ground as a ground cover. Alternatively the clips and attachment system of the invention may be used for fixing a sheet material approximately vertically or at an angle between horizontal and vertical as a wind break or sunshade, or for light reflecting, in relation to agricultural trees or plants. Alternatively again the clips and attachment system of the invention may be used for fixing in place agricultural netting, over or adjacent agricultural trees or plant.

The foregoing describes the invention including preferred forms thereof and alterations and modifications as will be obvious to one skilled in the art are intended to be incorporated in the scope thereof as defined in the accompanying claims.

1. A clip comprising:
a first inter-engageable part;
a second inter-engagable part, each of the first and the second inter-engagable parts having a jaw at first ends, the jaws being adapted to grip a sheet material between the jaws when the first and second inter-engageable parts are closed together;
a locking tab on the first inter-engageable part;
a locking bar on the second inter-engageable part, the locking bar engageable by the locking tab when the first and second inter-engagable parts are inter-engaged to lock the first and second inter-engagable parts in a closed position;
a first cord engaging formation at an opposite end of at least one of the first or second inter-engageable parts, the first cord engaging formation being adapted to grip a cord between the first cord engaging formation to lock the cord to the at least one of the first or second inter-engagable parts; and
a lengthwise cord channel located on at least one of the first or second inter-engagable parts,
wherein the cord engaging formation is positioned either side of the lengthwise cord channel in the opposite end of the at least one of the first or second inter-engagable parts.

2. (canceled)

3. The clip according to claim 1, wherein the first cord engaging formation comprises at least one projection on either side of the cord channel.

4. The clip according to claim 3, wherein the first cord engaging formation comprises at least a pair of adjacent projections from opposite sides of the cord channel.

5. The clip according to claim 4, wherein the first cord engaging formation is on each side of the cord channel and defines a slot between them.

6. The clip according to claim 1, wherein the first cord engaging formation is transverse to a longitudinal axis of the first or second inter-engagable part.

7. The clip according to claim 1, wherein the first cord engaging formation comprises a tooth edge.

8. The clip according to claim 1, further comprising:
a second cord engaging formation in the other of the at least the first or second inter-engagable parts, wherein at least one of the first or second cord engaging formations is angled relative to the longitudinal axis of the first or second inter-engagable part.

9. The clip according to claim 8, wherein at least one of the first or the second cord engaging formations is angled towards the first end of the first or second inter-engagable part and at least one of the first or second cord engaging formations is angled away from the first end of the the first or second inter-engagable part.

10. The clip according to claim 1, wherein the first cord engaging formation is at the opposite end of the first inter-engagable part and a second cord engaging part is at the opposite end of the second inter-engagable part.

11. The clip according to 1 comprising a cord aperture through said at least one of the first or second inter-engagable parts, between the cord engaging formation and the jaw of the first or the second inter-engagable part.

12. The clip according to claim 1 further comprising a first cord aperture through the first inter-engagable part and a second cord aperture through the second inter-engagable part, the first and second cord apertures are between the cord engaging formation and the jaws of the first and second inter-engagable parts.

13. The clip according to claim 12, wherein at least one of the first or second cord apertures through one of the first or second inter-engagable parts is an elongate slot aperture.

14. The clip according to claim 1, wherein the locking bar extends transverse to a length between the jaw and said opposite end of said other of the first or second inter-engagable parts and the locking tab on said one of the first or second inter-engagable parts comprises a longitudinally extending detent adapted to engage the locking bar to lock theme first and second inter-engagable parts together when the clip is closed.

15. The clip according to claim 14, wherein the detent comprises one or more teeth to engage the locking bar.

16. The clip according to claim 15, wherein one or more teeth are also provided on the locking bar to inter-engage with the one or more teeth on the detent when the first and second inter-engagable parts are closed together, to provide multiple relative positions in which the first and second inter-engagable parts can be locked and closed together.

17. The clip according to claim 1, wherein the jaws are the widest parts of the first and second inter-engagable parts, and the jaws are transverse to a length between the jaws and said opposite ends of the first and second inter-engagable parts.

18. A clip engagable with an edge of a sheet material to grip the edge of the sheet material comprising:
a first inter-engagable part and a second inter-engagable part, the first and second inter-engagable parts lock together to close the clip, each of the first and the second inter-engagable parts including a jaw at a first end of the first and the second inter-engagable parts, the jaws are adapted to grip the sheet material between the jaws when the first and second inter-engagable parts are locked together to close the clip, and each of the first and second inter-engagable parts including cord engaging formations and lengthwise cord channels, the cord engaging formations are on either side of the lengthwise cord channels and are adapted to grip a cord to lock the cord to the clip.

19. An attachment system comprising:
a cord;
a clip according to claim 1 attached to a first end of the cord; and
a hook engagable with the cord attached to a second end of the cord.

20. The attachment system according to claim 19, wherein the hook includes an elongate body having an aperture through which the cord passes.

21. The attachment system according to claim 20, wherein the hook is slidably mounted to the cord.

22. The attachment system according to claim 20, wherein the hook further includes a longitudinal locking cut-out adapted to grip the cord.

23. A method for fixing a sheet material, the method comprising:
attaching a cord to at least one clip including engaging the cord with cord engaging formations at ends of a first and a second inter-engagable part of the at least one clip, the cord being between the cord engaging formations attaching the cord to the clip;
attaching the cord to at least one hook;
engaging the at least one clip at a location along an edge of the sheet material, engaging the at least one clip including sliding the first inter-engageable part into the second inter-engageable part until the jaws are fully closed onto the edge of the sheet material, and locking the first and second inter-engagable parts together to fix the clip on the edge of the sheet material; and
looping the cord around wrapping the cord around an object and then hooking the hook back onto the cord.

24. The method according to claim 23, wherein attaching the cord to the at least one hook further comprises sliding the at least one hook along the cord to a selected location adjusting a length of the cord between the at least one clip and the at least one hook, and locking the cord in a longitudinal locking cut-out of the at least one hook.
